(19) United States
(12) Patent Application Publication
(10) Pub. No.: US 2014/0047813 A1
(43) Pub. Date: Feb. 20, 2014

(54) EXHAUST COLLECTOR WITH RADIAL AND CIRCUMFERENTIAL FLOW BREAKS

(71) Applicants: Javier Leonardo Frailich, Chula Vista, CA (US); Christopher Zdzislaw Twardochleb, Alpine, CA (US); Jiang Luo, San Diego, CA (US)

(72) Inventors: Javier Leonardo Frailich, Chula Vista, CA (US); Christopher Zdzislaw Twardochleb, Alpine, CA (US); Jiang Luo, San Diego, CA (US)

(73) Assignee: SOLAR TURBINES INCORPORATED, San Diego, CA (US)

(21) Appl. No.: 13/588,274

(22) Filed: Aug. 17, 2012

(51) Int. Cl. F01N 13/08; F02C 7/00

(52) U.S. Cl. 60/39.5; 60/697

(57) ABSTRACT

An exhaust collector having a radial inlet configured to receive exhaust gas in a radial direction, an outlet configured to deliver exhaust gas in and outlet direction, and an enclosure configured to collect the received exhaust gas into at least two circumferential counter flows, and route the collected exhaust gas to the outlet, wherein the enclosure includes a collected flow barrier configured to divide the collected exhaust gas from the exhaust gas received at the radial inlet, and a collected flow circumferential divider configured to form a physical barrier between at least a portion of the at least two circumferential counter flows.

### TECHNICAL FIELD

The present disclosure generally pertains to gas turbine engines, and is more particularly directed toward a gas turbine exhaust diffuser-collector system.

### BACKGROUND

A gas turbine engine generates high-velocity exhaust gas. The exhaust gas is diffused, routed, and released to the atmosphere. An exhaust diffuser can reduce the speed of the exhaust flow and increases the static pressure of the exhaust gas coming from the last stage of the turbine.

Presently, U.S. Pat. No. 6,419,448 to Owczarek describes a flow by-pass system for use in steam turbine exhaust hoods having a radial exhaust. The steam turbine includes a downward-discharging hood that collects the radial exhaust. The hood includes a vertical stiffening rib (8) extending from the bearing cone (9), along end wall (17) of exhaust hood top portion (14) and outer wall (16). The stiffening rib (8) serves to reinforce the outer wall (16) and stiffen exhaust hood top portion (14). The vertical stiffening rib (8) also separates the exhaust hood inlet vent (31) into two parts. In addition, Owczarek describes a lip or shroud (36) shaped so that it directs the flow from the by-pass conduit (41) in a generally downward direction toward the condenser. By extending downward for some distance in a direction parallel and adjacent to the end wall (17′), lip (36) prevents the main flow of steam in the bottom (outlet) portion of the exhaust hood from impinging at an angle on the flow exiting the outlet vent (34) and thereby enhances aspiration at such outlet.

The present disclosure is directed toward the performance of the exhaust collector and overcoming one or more problems discovered by the inventor.

### SUMMARY OF THE DISCLOSURE

An exhaust collector for a gas turbine engine is disclosed herein. The exhaust collector has a radial inlet configured to receive exhaust gas in a radial direction, an outlet configured to deliver exhaust gas in an outlet direction, and an enclosure configured to collect the received exhaust gas into at least two circumferential counter flows and route the collected exhaust gas to the outlet. The enclosure includes a collected flow barrier configured to divide the collected exhaust gas from the exhaust gas received at the radial inlet, and a collected flow circumferential divider configured to form a physical barrier between at least a portion of the at least two circumferential counter flows According to one embodiment, a gas turbine engine including the above exhaust collector is also disclosed herein.

### BRIEF DESCRIPTION OF THE DRAWINGS

FIG. 1 is a schematic illustration of an exemplary gas turbine engine.

FIG. 2 is a cutaway isometric view of a gas turbine engine exhaust collector.

FIG. 3 is a cutaway axial view of the gas turbine engine exhaust collector in FIG. 2.

FIG. 4 is a cutaway side view of a gas turbine engine exhaust collector, as taken along line 4-4 of FIG. 3.

### DETAILED DESCRIPTION

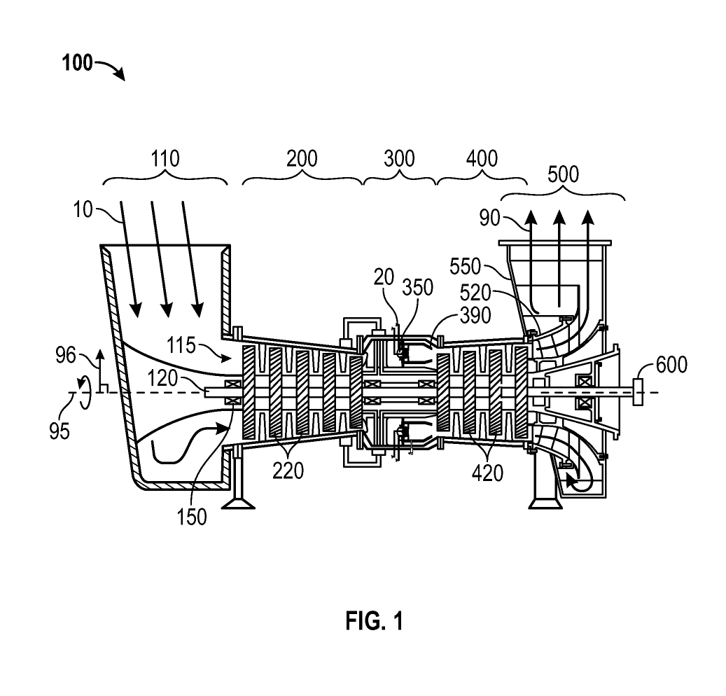

FIG. 1 is a schematic illustration of an exemplary gas turbine engine. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from the center axis 95 along a radial 96, A radial 96 may be in any direction perpendicular to and radiating outward from center axis 95.

Structurally, a gas turbine engine 100 includes an inlet 110, a gas producer or “compressor” 200, a combustor 300, a turbine 400, an exhaust 500, and a power output coupling 600. The compressor 200 includes one or more compressor rotor assemblies 220. The combustor 300 includes one or more injectors 350 and includes one or more combustion chambers 390. The turbine 400 includes one or more turbine rotor assemblies 420. The exhaust includes an exhaust diffuser 520 and an exhaust collector 550.

Functionally, a gas (typically air 10) enters the inlet 110 as a “working fluid”, and is compressed by the compressor 200. In the compressor 200, the working fluid is compressed in an annular flow path 115 by the series of compressor rotor assemblies 220. In particular, the air 10 is compressed in numbered “stages”, the stages being associated with each compressor rotor assembly 220. For example, “5th stage air” may be associated with the 5th compressor rotor assembly 220 in the downstream or “aft” direction—going from the inlet 110 towards the exhaust 500). Other numbering/naming conventions may also be used. Stages are similarly associated with each turbine rotor assembly 420

Once compressed air 10 leaves the compressor 200, it enters the combustor 300, where it is diffused and fuel 20 is added. Air 10 and fuel 20 are injected into the combustion chamber 390 via injector 350 and ignited. After the combustion reaction, energy is then extracted from the combusted fuel/air mixture via the turbine 400 by each stage of the series of turbine rotor assemblies 420. Exhaust gas 90 may then be diffused in exhaust diffuser 520 and collected, redirected, and exit the system via an exhaust collector 550. Exhaust gas 90 may also be further processed (e.g., to reduce harmful emissions, and/or to recover heat from the exhaust gas 90).

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

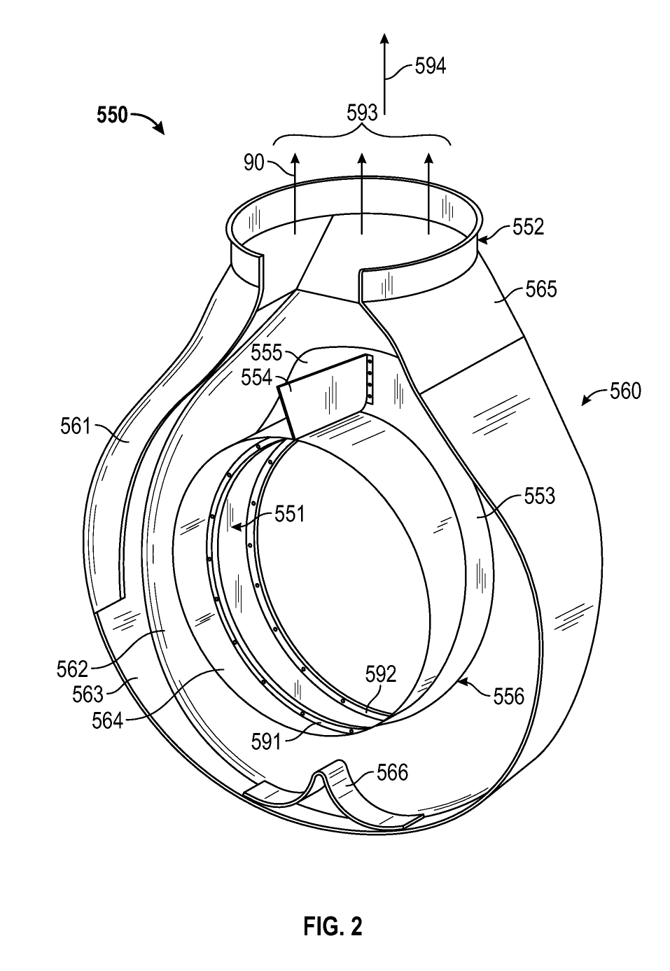

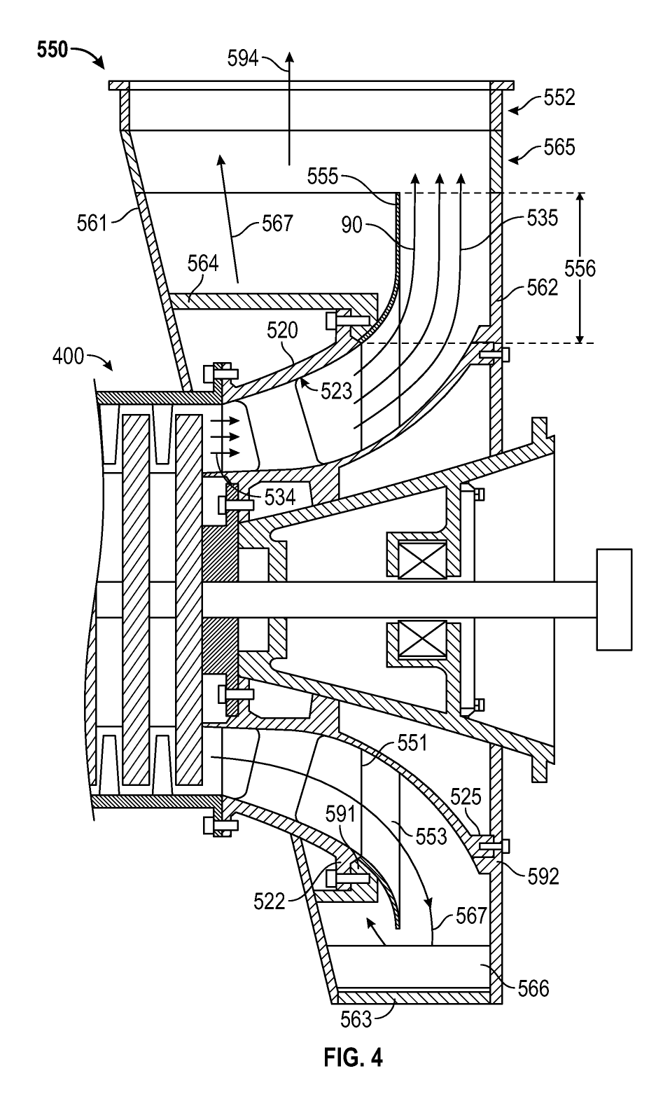

FIG. 2 is a cutaway isometric view of a gas turbine engine exhaust collector generally looking aft or downstream. In particular, the exhaust collector 550 schematically illustrated in FIG. 1 is shown here in greater detail, but in isolation from the rest of gas turbine engine 100. Exhaust collector 550 may be conceptualized as an enclosure 560 configured to receive a predominantly radial flow 535 (FIG. 4) of exhaust gas 90 from the exit of exhaust diffuser 520 (FIG. 1) and reroute it into a single, predominantly linear flow 593 along an outlet direction 594. Once the exhaust gas 90 has been collected and rerouted into the desired outlet direction 594, it may be discharged or interfaced with an extended routing system (not shown). For example, exhaust collector 550 may interface with a ceiling duct, venting to atmosphere. Equally, the exhaust collector 550 may interface with a preexisting post-processing system having a predefined exhaust interface.

As illustrated, exhaust collector 550 may include a radial inlet 551, an outlet 552, and an enclosure 560. All or some of the radial inlet 551, the outlet 552, and the enclosure 560 may be made for a single piece of material, or assembled and joined together to form a flow path for exhaust gas 90.

In addition, exhaust collector 550 may include radial flow and circumferential flow breaks such as a collected flow barrier 553 having an extended lip 555 or “bill”, and a collected flow circumferential divider 554. The collected flow barrier 553, the collected flow circumferential divider 554, may be fixed within the flow path and configured to interact with the flow of exhaust gas 90.

As shown, radial inlet 551 receives exhaust gas 90 having a predominantly radial flow 535 (FIG. 4) from exhaust diffuser 520 (FIG. 1). According to one embodiment, radial inlet 551 may be formed by two concentric, axially offset interfaces, which are configured to provide a passageway for the exhaust gas 90 to enter the enclosure 560. In particular, radial inlet 551 may include a forward exhaust diffuser mounting interface 591 and an aft exhaust diffuser mounting interface 592. The forward exhaust diffuser mounting interface 591 may mechanically couple with a reciprocal mounting interface on the exhaust diffuser 520 (FIG. 1) at its exit Likewise, the aft exhaust diffuser mounting interface 592 may mechanically couple with a reciprocal mounting interface on the exhaust diffuser 520 (FIG. 1) at its exit. When mechanically coupled, the pairs of interfaces may complete a fluid couple between the exhaust diffuser 520 (FIG. 1) and the exhaust collector 550 such that exhaust gas 90 may pass there between.

According to the illustrated embodiment, the enclosure 560 may include a forward wall 561 (shown partially cut away), an aft wall 562, a circumferential exterior wall 563, and an interior collector wall 564. Thus, after exhaust gas 90 enters radial inlet 551 it is collected in the annular region between the circumferential exterior wall 563 and the interior collector wall 564. All or some of the forward wall 561, the aft wall 562, the circumferential exterior wall 563, and the interior collector wall 564, may be made for a single piece of material, or assembled and joined together from sheets of material (e.g., sheet metal). Additional features such as external support interfaces, stiffening ribs, etc. are contemplated with one or more of the above components.

According to one embodiment and as illustrated, enclosure 560 may include a transition section 565 (shown partially cut away). In particular, the transition section 565 bridges a gap between the geometry, or the location, of the enclosure 560 and that of a receiver (not shown) of the exhaust gas 90. For example, outlet 552 may have a round shape whereas the combination of the forward wall 561, the aft wall 562, and the circumferential exterior wall 563 may result in a rectangular shape. Accordingly, the transition section 565 may begin with a rectangular shape and gradually transition to a round shape across the distance between the rest of the enclosure 560 and the mating interface with the outlet 552.

According to one embodiment, the enclosure 560 may be shaped for efficient manufacturing as well as for performance. In particular, while enclosure 560 may include compound curved surfaces, flat and planar surfaces may be used instead for the collector walls. In this way, manufacturing concerns such as low cost, easy assembly and maintenance may be addressed. For example, the forward wall 561 and the aft wall 562 of the enclosure 560 may be made from flat sheet metal sections, without the need for complex forming, such as using forming dies Likewise, circumferential exterior wall 563, interior collector wall 564, and outlet 552 may all be made using simple sheet metal fabrication and joining techniques. Depending on the shape of the outlet 552, which may depend on the facility where the gas turbine engine 100 is installed, transition section 565 may also be made using simple sheet metal fabrication and joining techniques.

Within the exhaust collector 550, the flow of the exhaust gas 90 is redirected by the aft wall 562, and moves upward along the circumferential exterior wall 563, but also back toward the forward wall 561. The exhaust gas 90 then accumulates forward of the collected flow barrier 553 (i.e., away from the aft wall 562 and the predominantly radial flow 535 (FIG. 4)), and continues to move upward along the circumferential direction toward the outlet 552 before exiting.

Due to the strong turning involved, the flow may roll into two screw type vortices (one on each side) inside the exhaust collector 550 and swirl toward the outlet 552. As such, the exhaust collector 550 may include additional features to address vorticity and flow losses, discussed further below. Some of these features are illustrated and may include the collected flow barrier 553, the collected flow circumferential divider 554, leaning the forward wall 561 at a predetermined angle (as opposed to aligning it with the exiting flow), and including an impinging radial flow splitter 566.

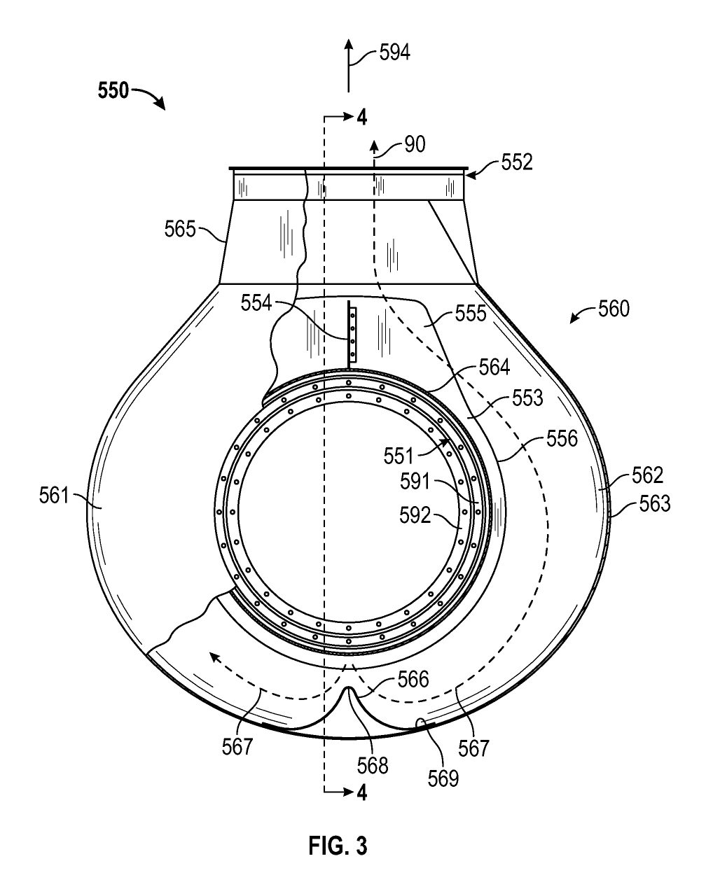

FIG. 3 is a cutaway axial view of a gas turbine engine exhaust collector. In particular, the exhaust collector 550 schematically illustrated in FIG. 1 is shown here in greater detail, but in isolation from the rest of gas turbine engine 100. Here, the exhaust collector 550 is shown looking aft or downstream, and with its forward wall 561 partially removed to view the components internal to its enclosure 560.

As discussed above, the exhaust collector 550 may include an impinging radial flow splitter 566. In particular, impinging radial flow splitter 566 may be symmetrically located opposite the outlet 552 such that it “splits” radial flow into at least two diverging circumferential counter flows 567. Each circumferential counter flow 567 may then travel in opposite circumferential directions until reconverging near the outlet 552 (or transition section 565). In addition, the two diverging circumferential counter flows 567 may travel toward the forward wall 561 and accumulate with other redirected flow.

The impinging radial flow splitter 566 may axially extend between the forward wall 561 and the aft wall 562, as shown in FIG. 4. The impinging radial flow splitter 566 may have a narrow leading edge 568 and a wide base 569. The leading edge 568 may face the radial flow of exhaust gas 90, expand smoothly from the leading edge 568 to its base 569, and transition into the circumferential exterior wall 563 where it may be attached or otherwise fixed.

According to one embodiment, impinging radial flow splitter 566 may include a symmetric metal sheet fixed to the circumferential exterior wall 563. Alternately, the impinging radial flow splitter 566 may be formed directly into the enclosure 560 by denting or otherwise shaping the circumferential exterior wall 563 into the splitting shape described above. Also, here, the impinging radial flow splitter 566 is shown on the ventral side of exhaust collector 550 for convenience; however as discussed above, outlet 552, and thus, the impinging radial flow splitter 566 may both be rotated to any convenient outlet direction 594.

As discussed above, the exhaust collector 550 may include a collected flow barrier 553, having an extended lip 555. The collected flow barrier 553 may extend radially from the radial inlet 551 such that it forms a mechanical barrier between the predominantly radial flow 535 (FIG. 4) first entering the exhaust collector 550 and the exhaust gas 90 that has been redirected by the aft wall 562 and is collected towards the forward wall 561. The radial distance that collected flow barrier 553 extends beyond the radial inlet 551 may reflect the flow rates of the exhaust gas 90 exiting the exhaust diffuser 520, the geometry of the collection area between the collected flow barrier 553 and the forward wall 561, and any back pressure at the outlet 552.

According to one embodiment, the collected flow barrier 553 may include a non-uniform outer radius 556, wherein the outer radius 556 increases as it circumferentially approaches the outlet 552. In the illustrated configuration, the outer radius 556 remains generally constant, but then gradually increases as it approaches the transition section 565. Having a non-uniform outer radius 556, the collected flow barrier 553 may include linear or other non-round portions. In addition, the collected flow barrier 553 may extend at least two or three times the radial distance from the forward exhaust diffuser mounting interface 591 at its extended lip 555 than the outer radius 556 at the opposite side of the extended lip 555.

Also, as collected flow barrier 553 begins to radially align with passageway though the transition section 565, a smaller portion of the flow exiting the exhaust diffuser 520 (FIG. 1) is accumulating or being collected in the area between collected flow barrier 553 and the forward wall 561. As such, collected flow barrier 553 may extend radially at an even greater rate, providing a greater break between the collected flow and the flow exiting the exhaust diffuser 520. For example, according to one embodiment, the outer radius 556 of the collected flow barrier 553 may reach out radially to the flow area bound by the transition section 565.

As discussed above, the exhaust collector 550 may include a collected flow circumferential divider 554. In particular, collected flow circumferential divider 554 may include a physical barrier between the circumferential counter flows 567 as they circumferentially approach each other near the outlet 552 (or transition section 565). Collected flow circumferential divider 554 may include a sheet or other type of dividing member, which is oriented and configured to form a barrier to opposing flows and vortices that circumferentially travel toward and meet at the outlet 552 (or transition section 565).

According to one embodiment, the collected flow circumferential divider 554 may extend substantially into the collected flow so as to interrupt or otherwise decrease the interaction of the reconverging circumferential counter flows 567. Axially, the collected flow circumferential divider 554 may extend from the collected flow barrier 553 to the forward wall 561. Where the collected flow barrier 553 includes an extended lip 555, the collected flow circumferential divider 554 may radially extend from the interior collector wall 564 to a radial length matching the outer radius 556 of the extended lip 555. Alternately, the collected flow circumferential divider 554 may radially extend to at least to a radial length seventy-five percent of the radial length of the extended lip 555.

For example, according to one embodiment, the collected flow circumferential divider 554 may radially extend such that it is limited only by the dimensions of nearby components. In particular, the collected flow circumferential divider 554 may extend radially from the interior collector wall 564 outward to an area where the exhaust gas 90 is substantially linear. For example, the collected flow circumferential divider 554 may radially extend from the interior collector wall 564 substantially to the outlet 552 and/or to the transition section 565 (where present). Alternately, the collected flow circumferential divider 554 may radially extend to at least seventy-five percent of the radial distance from the interior collector wall 564 to the outlet 552 and/or to the transition section 565 (where present).

According to one embodiment, the collected flow circumferential divider 554 may be configured to work in conjunction with the collected flow barrier 553 so as to interrupt the commingling of the reconverging circumferential counter flows 567, as well as the radial flow exiting the exhaust diffuser 520 (FIG. 1). In particular, they may be combined or otherwise placed substantially adjacent to each other, and extend radially such that they interrupt the flow components that are orthogonal to the outlet direction 594 (i.e., circumferential and axial flow components). In addition, the dimensions of the collected flow barrier 553 and the collected flow circumferential divider 554 may be adjusted such that back pressure from colliding vortices or other interacting flows of exhaust gas 90 is minimized, based on operational conditions.

According one embodiment, the collected flow circumferential divider 554 may be not only proximate to, but physically joined, or otherwise fastened to the collected flow barrier 553 and to one or more other surfaces. In particular, the collected flow circumferential divider 554 may be configured to provide structural support to the collected flow barrier 553, in addition to merely dividing the opposing circumferential flows. For example, the collected flow circumferential divider 554 may be mechanically coupled (“anchored”) to one or more of the interior collector wall 564, the forward wall 561, and the transition section 565. According to one embodiment, the collected flow circumferential divider 554 may be made from a flat pattern where one or more angles are added to provide attachment surfaces.

This added support structure may provide for extending the extended lip 555 of collected flow barrier 553 even further into the radial flow than if the collected flow barrier 553 were purely self-supporting, or alternately extended lip 555 may be made of a thinner material that if it were without the added support of collected flow circumferential divider 554. Likewise, collected flow circumferential divider 554 may be extended further into the radial flow than if it were purely self-supporting. Also, as an added support structure, collected flow circumferential divider 554 may be further configured to attenuate any harmonic or transitory motion of the collected flow barrier 553 during engine operation.

### INDUSTRIAL APPLICABILITY

The present disclosure generally provides an exhaust collector, and a gas turbine engine having an exhaust collector. As applied, gas turbine engines, and thus their components, may be suited for any number of industrial applications, such as, but not limited to, various aspects of the oil and natural gas industry (including include transmission, gathering, storage, withdrawal, and lifting of oil and natural gas), power generation industry, aerospace and transportation industry, to name a few examples.

FIG. 4 is a cutaway side view of a gas turbine engine exhaust collector, as taken along line 4-4 of FIG. 3, with the addition of partial views of its mounting components for contextual purposes. Here, structural features, interface features, and additional flow efficiency features are shown.

As discussed above, exhaust collector 550 may mechanically and fluidly couple with exhaust diffuser 520. In particular, the forward exhaust diffuser mounting interface 591 may mechanically couple with an outer exhaust collector mounting interface 522. Likewise, the aft exhaust diffuser mounting interface 592 may mechanically couple with an inner exhaust collector mounting interface 525. As shown, the exhaust diffuser 520 may receive exhaust gas 90 in a predominantly axial flow 534, impart a radial direction to the exhaust gas 90 and transmit a predominantly radial flow 535. Also as shown, the two axially offset, concentric mechanical couples provide for the predominantly radial flow 535 exiting exhaust diffuser 520 to enter radial inlet 551 of exhaust collector.

As discussed above, after exhaust gas 90 enters radial inlet 551 it is collected in the annular region between the circumferential exterior wall 563 and the interior collector wall 564. As illustrated, at the opposite end of outlet 552, once exhaust gas 90 is divided in two circumferential counter flows 567 by the impinging radial flow splitter 566, each half of the split flow wraps around the collected flow circumferential divider 554. Each half of the split flow then travels circumferentially around opposite sides of the interior collector wall 564. The remainder of the predominantly radial flow 535 leaving the exhaust diffuser 520 is also collected. However, approaching the outlet 552, a decreasing portion of the predominantly radial flow 535 crosses over the collected flow barrier 553 in the axial direction.

As discussed above, the exhaust collector 550 may include additional features to address vorticity and flow losses. For example, the exhaust collector 550 may include the collected flow barrier 553 having an extended lip 555. The collected flow barrier 553 sometimes called a “duck bill” (for the shape of its profile), may include an annular or partially annular sheet flaring out and extending radially from the outer diffuser flow wall 523. The collected flow barrier 553 may transition from an angle approximately that of the flow exit angle of the exhaust diffuser 520 (predominantly radial, but having an axial component), to being substantially radial in direction. The outer radius 556 of the collected flow barrier 553 may extend such that interaction with the collected flow is reduced.

The combination of the collected flow circumferential divider 554 and the collected flow barrier 553 is particularly beneficial in addressing performance problems associated with vorticity and flow losses. In particular, collected flow circumferential divider 554 provides a physical barrier between colliding vortices approaching from opposite circumferential directions. This provides for flow redirection to the outlet direction 594 with reduced back pressure from vortex interaction.

In addition, the inventor has discovered that the combination of the collected flow circumferential divider 554 and the collected flow barrier 553 as a mutual support structure provides for a much greater radial extension in the outlet direction 594 of both than if used individually. Alternately, to support the forces on the collected flow barrier 553 a much more robust (and costly) design would be required. However, by combining the two flow structures in the described mutually supporting manner, the inventor has discovered that the collected flow barrier 553 made of a thinner material may be used.

Also as discussed above, the collected flow barrier 553 may include a non-uniform outer radius 556. As can be seen at the opposite end of outlet 552 (here, the lower end), all exhaust gas 90 must be collected and redirected toward the outlet 552. Accordingly, the outer radius 556 of the collected flow barrier 553 may be minimized to provide for the least resistance to being redirected and collected.

In contrast, exhaust gas 90 entering exhaust collector 550 at the end having the outlet 552 (here, the upper end) is already flowing predominantly in the outlet direction 594. As such very little of exhaust gas 90 must be collected and redirected. Accordingly, outer radius 556 of the collected flow barrier 553 may be maximized as a physical barrier between the flow leaving the exhaust diffuser 520 and the collected flow.

According to one embodiment, the rate of change of the outer radius 556 may be non-linear. In particular, the outer radius 556 may reflect the degree of redirection and desired resistance to interaction between the radial flow and the collected flow. For example, the collected flow barrier 553 may have a relatively constant outer radius 556 in the half furthest from the outlet 552, but dramatically increase in the other half as it approaches the outlet 552.

As discussed above, the exhaust collector 550 may include “leaning” the forward wall 561 at a predetermined angle. More specifically, the approach is to optimize the cross-sectional area of exhaust collector 550 in the circumferential direction. Since the mass flow rate increases approximately linearly from zero at the bottom to the total mass rate at the top (collector exit) due to the flow accumulation, the exhaust collector 550 cross-sectional area (forward of the collected flow barrier 553) should also increase linearly in the circumferential direction. It should start from zero to match the increase of mass flow rate to maintain a uniform through flow velocity. A larger collector volume at the bottom will only provide more space for vortex formation.

According to one embodiment, the circumferential exterior wall 563 may be kept a constant radius. As such, the dimension of radial cross section of annular region between the circumferential exterior wall 563 and the interior collector wall 564 is almost constant, since the diffuser ends at a constant radius. Therefore, rather than making the forward wall 561 be parallel to the aft wall 562, the forward wall 561 may be leaned away from the aft wall 562. In particular, the forward wall 561 may be leaned such that the radial cross-section dimension in the axial direction have a linear increase, which results in the linear increase of the flow passage area.

Additionally, the disclosed exhaust collector is particularly applicable to the use, operation, maintenance, repair, and improvement of gas turbine engines. Specifically, the exhaust collector may be suited for the design, manufacture, test, repair, overhaul, and improvement of exhaust collector where there are constraints on space or exhaust direction, or where delivering air to a preexisting exhaust structure would be desirable.

In order to improve efficiency, decrease maintenance, and lower costs, embodiments of the presently disclosed exhaust collector may be used on exhaust systems at any stage of the gas turbine engine's life, from first manufacture and prototyping to end of life. In addition, the simplified design, maximizing planar surfaces may be easier to build and maintain than exhaust collector systems that are more bulky and/or include enclosures having complex geometry. Furthermore, the additional features to address vorticity and flow losses, may outperform other exhaust collectors such that greater engine efficiency is available and/or smaller, more compact exhaust collectors may be used.

Accordingly, the disclosed exhaust collector may be used as an enhancement to existing gas turbine engine exhaust system, as a preventative measure, or even in response to an event. This is particularly true as the presently disclosed exhaust collector may conveniently include identical mounting interfaces to an older type of exhaust collector.

Although this invention has been shown and described with respect to a detailed embodiment thereof, it will be understood by those skilled in the art that various changes in form and detail thereof may be made without departing from the spirit and scope of the claimed invention. Accordingly, the preceding detailed description is merely exemplary in nature and is not intended to limit the invention or the application and uses of the invention. In particular, the described embodiments are not limited to use in conjunction with a particular type of gas turbine engine. For example, the described embodiments may be applied to stationary or motive gas turbine engines, or any variant thereof.

It will be recognized that in some instances the described embodiments may also be used in machines that also produce high temperature, high speed exhaust air. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

What is claimed is:

1. An exhaust collector for a gas turbine engine, the exhaust collector comprising:
a radial inlet having a center axis and including a forward exhaust diffuser mounting interface and an aft exhaust diffuser mounting interface, the radial inlet configured to receive exhaust gas radially, relative to the center axis, through an circumferential opening bounded by the forward exhaust diffuser mounting interface and the aft exhaust diffuser mounting interface;
an outlet having an outlet direction and configured to deliver exhaust gas from the exhaust collector in the outlet direction;
an enclosure configured to collect the received exhaust gas from the radial inlet into at least two circumferential counter flows, and further configured to route the collected exhaust gas to the outlet via the at least two circumferential counter flows;
a collected flow barrier radially extending from the radial inlet within in the enclosure, and configured to at least partially divide the collected exhaust gas from the exhaust gas received at the radial inlet; and
a collected flow circumferential divider within in the enclosure, the collected flow circumferential divider configured to form a physical barrier between at least a portion of the at least two circumferential counter flows.

2. The exhaust collector of claim 1, wherein the enclosure includes a forward wall, an aft wall, a circumferential exterior wall, and an interior collector wall;
wherein the circumferential exterior wall axially extends between the forward wall and the aft wall;
wherein the interior collector wall axially extends forward of the forward exhaust diffuser mounting interface to the forward wall; and
wherein the collected flow circumferential divider radially extends from the interior collector wall, and axially extends between the forward wall and the collected flow barrier.

3. The exhaust collector of claim 1, wherein the collected flow barrier has a non-uniform outer radius; and
wherein the outer radius of the collected flow barrier increases as it circumferentially approaches the outlet.

4. The exhaust collector of claim 3, wherein the collected flow circumferential divider is fastened to the collected flow barrier and to the forward wall.

5. The exhaust collector of claim 4, wherein at least a portion of the collected flow circumferential divider radially extends to toward the outer radius of the collected flow barrier along a radial in the outlet direction so as to provide structural support to the collected flow barrier.

6. The exhaust collector of claim 2, wherein the forward wall is slanted such that the distance between the forward wall and the aft wall increases as they approach the outlet.

7. The exhaust collector of claim 2, wherein at least a portion of the collected flow circumferential divider radially extends in the outlet direction substantially into the collected exhaust gas so as to interrupt or otherwise decrease the interaction of the at least two circumferential counter flows as they reconverge at the outlet.

8. The exhaust collector of claim 2, wherein the enclosure further includes a transition section having a first end and a second end, the transition section being mechanically coupled to the forward wall, the aft wall, and the circumferential exterior wall at the first end, and the transition section being mechanically coupled to the outlet at the second end;
wherein the first end of the transition section has a rectilinear shape and the second end of the transition section has a round shape.

9. The exhaust collector of claim 8, wherein at least a portion of the collected flow circumferential divider radially extends in the outlet direction substantially to the first end of the transition section.

10. The exhaust collector of claim 1, further comprising an impinging radial flow splitter radially located opposite the outlet, the impinging radial flow splitter having a leading edge and a base, the leading edge facing the exhaust gas received in a radial direction opposite outlet direction, the leading edge and the base configured to divide the exhaust gas received in the radial direction opposite outlet direction into the at least two circumferential counter flows.

11. A gas turbine engine comprising:
an inlet;
a compressor;
a combustor;
a turbine;
an exhaust diffuser configured to receive exhaust gas from the turbine in a predominantly axial flow, impart a radial direction to the exhaust gas and transmit a predominantly radial flow; and
an exhaust collector having
a radial inlet having a center axis and including a forward exhaust diffuser mounting interface and an aft exhaust diffuser mounting interface, the radial inlet configured to receive exhaust gas radially, relative to the center axis, through an circumferential opening bounded by the forward exhaust diffuser mounting interface and the aft exhaust diffuser mounting interface,
an outlet having an outlet direction and configured to deliver exhaust gas from the exhaust collector in the outlet direction,
an enclosure configured to collect the received exhaust gas from the radial inlet into at least two circumferential counter flows, and further configured to route the collected exhaust gas to the outlet via the at least two circumferential counter flows,
a collected flow barrier radially extending from the radial inlet within in the enclosure, and configured to at least partially divide the collected exhaust gas from the exhaust gas received at the radial inlet, and
a collected flow circumferential divider within in the enclosure, the collected flow circumferential divider configured to form a physical barrier between at least a portion of the at least two circumferential counter flows.

12. The gas turbine engine of claim 11, wherein the enclosure includes a forward wall, an aft wall, a circumferential exterior wall, and an interior collector wall;
wherein the circumferential exterior wall axially extends between the forward wall and the aft wall;
wherein the interior collector wall axially extends forward of the forward exhaust diffuser mounting interface to the forward wall; and
wherein the collected flow circumferential divider radially extends from the interior collector wall, and axially extends between the forward wall and the collected flow barrier.

13. The gas turbine engine of claim 11, wherein the collected flow barrier has a non-uniform outer radius; and
wherein the outer radius of the collected flow barrier increases as it circumferentially approaches the outlet.

14. The gas turbine engine of claim 13, wherein the collected flow circumferential divider is fastened to the collected flow barrier and to the forward wall.

15. The gas turbine engine of claim 14, wherein at least a portion of the collected flow circumferential divider radially extends to toward the outer radius of the collected flow barrier along a radial in the outlet direction so as to provide structural support to the collected flow barrier.

16. The gas turbine engine of claim 12, wherein the forward wall is slanted such that the distance between the forward wall and the aft wall increases as they approach the outlet.

17. The gas turbine engine of claim 12, wherein at least a portion of the collected flow circumferential divider radially extends in the outlet direction substantially into the collected exhaust gas so as to interrupt or otherwise decrease the interaction of the at least two circumferential counter flows as they reconverge at the outlet.

18. The gas turbine engine of claim 12, wherein the enclosure further includes a transition section having a first end and a second end, the transition section being mechanically coupled to the forward wall, the aft wall, and the circumferential exterior wall at the first end, and the transition section being mechanically coupled to the outlet at the second end;
wherein the first end of the transition section has a rectilinear shape and the second end of the transition section has a round shape.

19. The gas turbine engine of claim 18, wherein at least a portion of the collected flow circumferential divider radially extends in the outlet direction substantially to the first end of the transition section.

20. The gas turbine engine of claim 11, further comprising an impinging radial flow splitter radially located opposite the outlet, the impinging radial flow splitter having a leading edge and a base, the leading edge facing the exhaust gas received in a radial direction opposite outlet direction, the leading edge and the base configured to divide the exhaust gas received in the radial direction opposite outlet direction into the at least two circumferential counter flows.
